(19) United States
(12) Patent Application Publication
(10) Pub. No.: US 2021/0311773 A1
(43) Pub. Date: Oct. 7, 2021

(54) Efficient Condition Variables via Delegated Condition Evaluation

(71) Applicant: Oracle International Corporation, Redwood City, CA (US)

(72) Inventors: Alex Kogan, Burlington, MA (US); David Dice, Burlington, MA (US)

(21) Appl. No.: 16/837,856

(22) Filed: Apr. 1, 2020

(51) Int. Cl. G06F 9/46; G06F 9/52

(52) U.S. Cl. CPC G06F 9/466; G06F 9/52

(57) ABSTRACT

Efficient use of condition variables for communication between threads of a multi-threaded application may be ensured using delegated condition evaluation. A thread in a runnable state may request to wait for a change to a condition, the request including instructions that, when executed, return a value indicating if the wait is to be terminated. The thread may then be placed in a non-runnable state waiting for a change to the condition, and upon determining a change to the condition, the instructions are executed to receive the value indicating if the wait is to be terminated. If the value indicates that the wait is to be terminated, the thread is placed in a runnable state. If the value indicates that the wait is not to be terminated, the thread remains in a non-runnable state.

### BACKGROUND

### Field of the Disclosure

This disclosure relates generally to concurrent programming, and more particularly to systems and methods for performing concurrent synchronization using condition variables.

### Description of the Related Art

Modern computer systems conventionally include the ability to run multiple threads of execution simultaneously, thus giving rise to the need to synchronize threads for access to shared data structures. Among these synchronization mechanisms is the condition variable. Condition variables allow threads to block and wait until a certain condition holds and enable threads to wake up their blocked peers by notifying them about a change to the state of shared data. Often, change of state notifications are provided to all threads even if only a small number of specific threads are affected. This results in so-called futile wakeups, where threads receiving the notification resume execution only to wait again. These futile wakeups cause numerous context switches while increasing lock contention and cache pressure, significantly reducing computing performance.

### SUMMARY

A thread of a multi-thread application may request to wait for a change to a condition, the request including instructions that, when executed, return a value indicating if the wait is to be terminated. The thread may then be placed in a non-runnable state waiting for a change to the condition, and upon determining a change to the wait condition, the function is executed to receive a value indicating if the wait is to be terminated. If the value indicates that the wait is to be terminated, the thread is placed in a runnable state. If the value indicates that the wait is not to be terminated, the thread remains in a non-runnable state.

### BRIEF DESCRIPTION OF THE DRAWINGS

FIG. 1 is a block diagram of an exemplary computing system employing condition variables with deferred condition evaluation, according to some embodiments.

FIGS. 2A-2B are flow diagrams illustrating methods and techniques for implementing synchronization of threads using condition variables, according to some embodiments.

FIGS. 3A-3C are flow diagrams illustrating methods and techniques for implementing wait, signal and broadcast functions supporting condition variables with deferred condition evaluation, according to some embodiments.

FIG. 4 is example code implementing a bounded queue algorithm using condition variables with deferred condition evaluation, according to some embodiments.

FIGS. 5A-5B illustrate example analyses of legacy and deferred condition evaluation throughput and futile wake-ups for a bounded queue application, according to some embodiments.

FIG. 6 illustrates an example computing system, according to some embodiments.

While the disclosure is described herein by way of example for several embodiments and illustrative drawings, those skilled in the art will recognize that the disclosure is not limited to embodiments or drawings described. It should be understood that the drawings and detailed description hereto are not intended to limit the disclosure to the particular form disclosed, but on the contrary, the disclosure is to cover all modifications, equivalents and alternatives falling within the spirit and scope as defined by the appended claims. Any headings used herein are for organizational purposes only and are not meant to limit the scope of the description or the claims. As used herein, the word “may” is used in a permissive sense (i.e., meaning having the potential to) rather than the mandatory sense (i.e. meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. § 112(f) interpretation for that unit/circuit/component.

This specification includes references to “one embodiment” or “an embodiment.” The appearances of the phrases “in one embodiment” or “in an embodiment” do not necessarily refer to the same embodiment, although embodiments that include any combination of the features are generally contemplated, unless expressly disclaimed herein. Particular features, structures, or characteristics may be combined in any suitable manner consistent with this disclosure.

### DETAILED DESCRIPTION OF EMBODIMENTS

Modern computing applications employ multiple threads of execution which may execute concurrently on multiple processor cores and typically share a common memory address space. This common memory address space may include globally allocated memory variables and a shared memory heap. Multi-threaded applications therefore require synchronization mechanisms to ensure proper utilization of data stored in this common, shared memory space.

One such synchronization mechanism is condition variables. Condition variables enable threads to wait until a particular condition occurs, for example an item is put into a queue, before resuming the execution of a critical section under a lock, for example removing that item from the queue for processing.

A programmatic interface, such as an Application Programming Interface (API), for condition variables may in some embodiments include three calls: wait, signal and broadcast. The wait call may be used to wait for a condition by blocking, or parking, a calling thread and atomically releasing the lock it is holding. The signal call is used to notify one of a number of waiting threads that a condition it has been waiting for may have changed, and the broadcast call is similar to the signal call but sends a notification to all waiting threads. Upon receiving a notification, a thread wakes up, or unblocks, acquires the lock which it was holding when it called the wait function and evaluates a respective condition, calling wait again if the condition has not been met.

The broadcast call is most suitable when all threads waiting for a condition would be able to proceed, that is if their condition would be satisfied, once they are notified. For instance, broadcast is commonly used to implement barriers in multi-phase computation, allowing threads to synchronize at the boundaries of each phase. Often, however, change of state notifications are provided to all threads using a broadcast mechanism even though only a small number of threads may be affected by the particular change of state. This may result in futile wakeups, where threads receiving the notification resume execution only to determine a need to wait again. These futile wakeups cause numerous context switches while increasing lock contention and cache pressure, significantly reducing computing performance.

Various techniques for implementing condition variables with deferred condition evaluation are described herein. This deferred condition evaluation (DCE) feature enables condition variable synchronization to evaluate conditions and send the notifications only to the relevant threads, largely or completely eliminating futile wakeups.

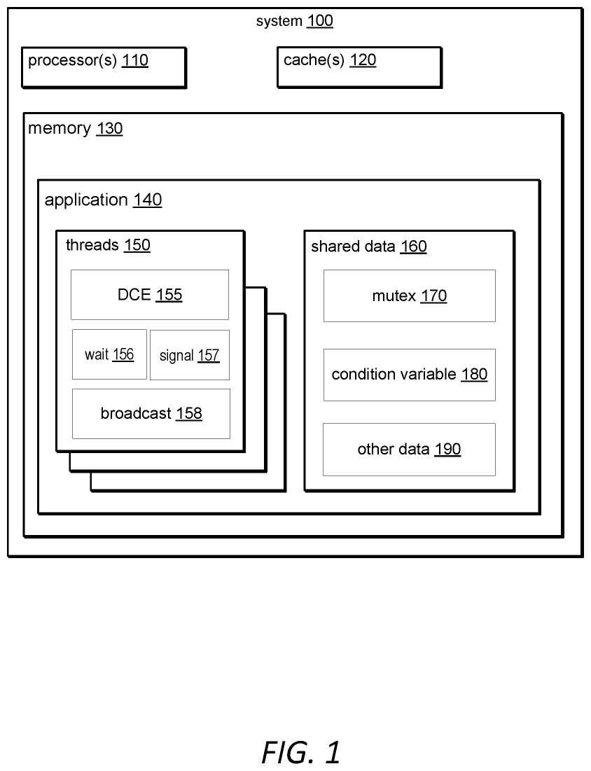

FIG. 1 is a block diagram of an exemplary computing system 100 implementing a multi-threaded application 140 with DCE according to some embodiments. The system 100 includes one or more processors 110 capable of executing multiple parallel threads of execution coupled through one or more caches 120 to a memory 130 that includes an application 140.

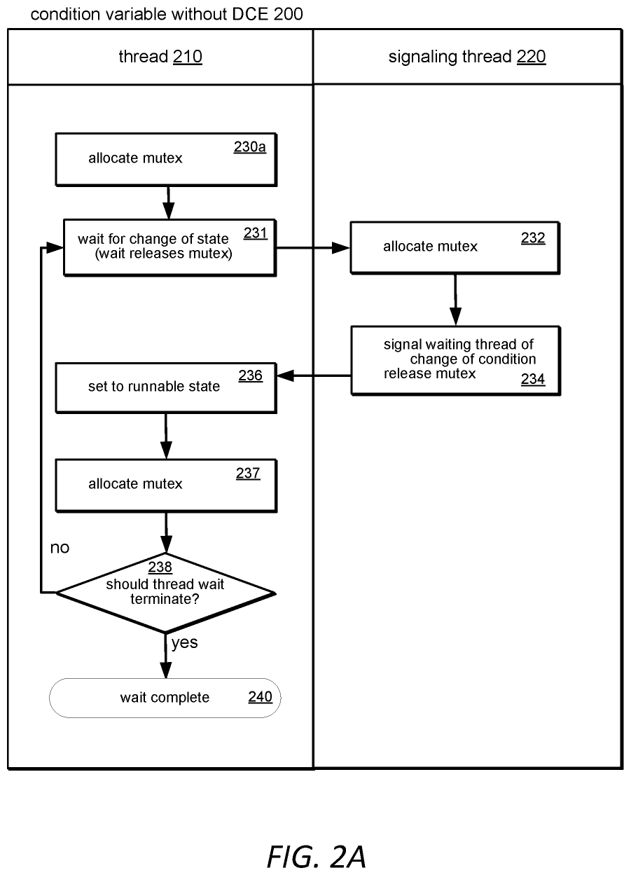

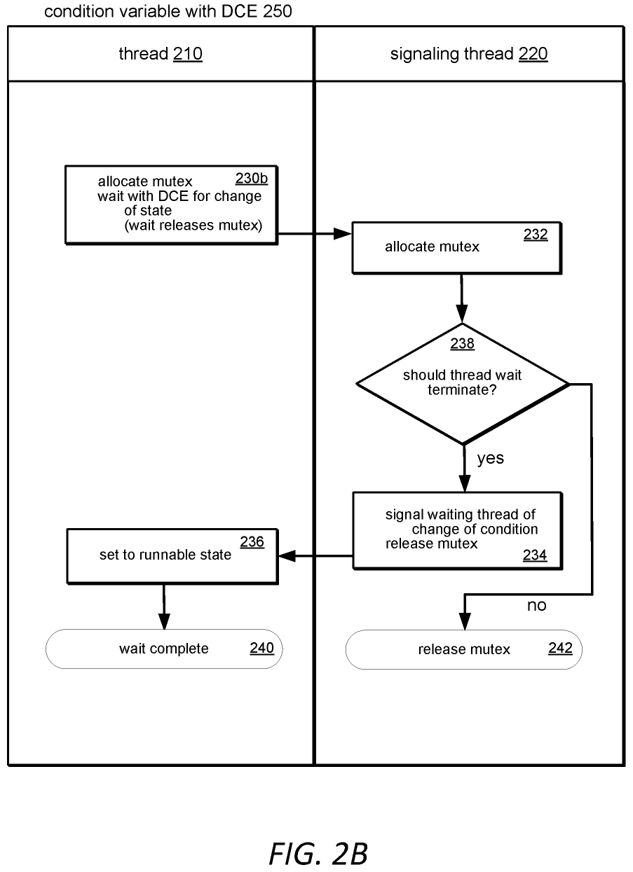

The application 140 may include multiple executing threads 150 that access a shared data 160. Each of the threads 150 includes an executable DCE function 155 as illustrated in FIGS. 2-4. In addition, the threads 150 may call functions of a synchronization API which includes a wait function 156, and one or more signaling functions such as signal function 157 and broadcast function 158. The shared variables 160 include a mutual exclusion variable (mutex) 170, as illustrated in FIG. 2, and a condition variable 180 and may also include other data 190, all sharable by the threads 150.

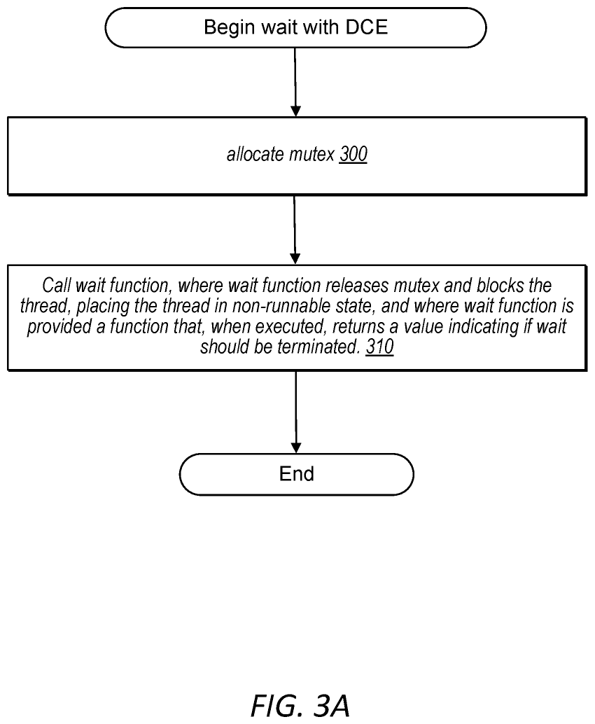

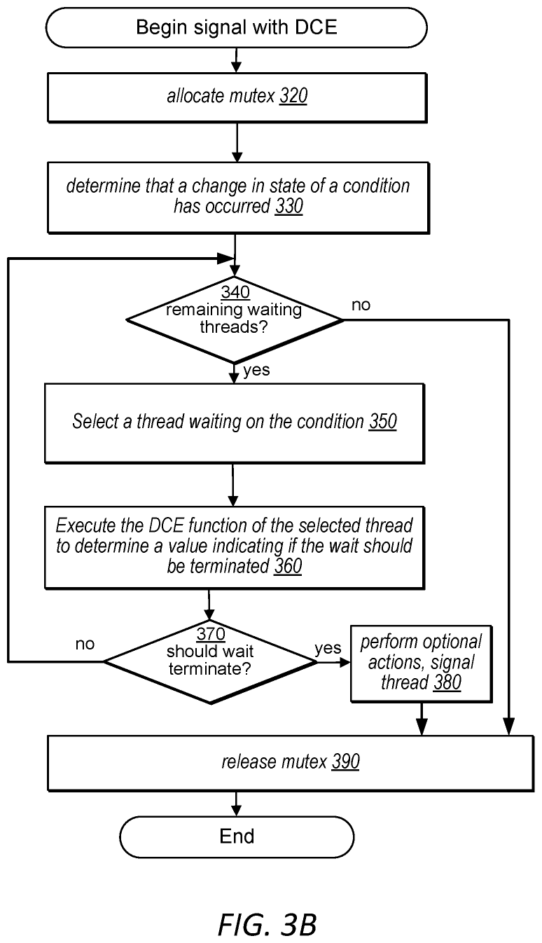

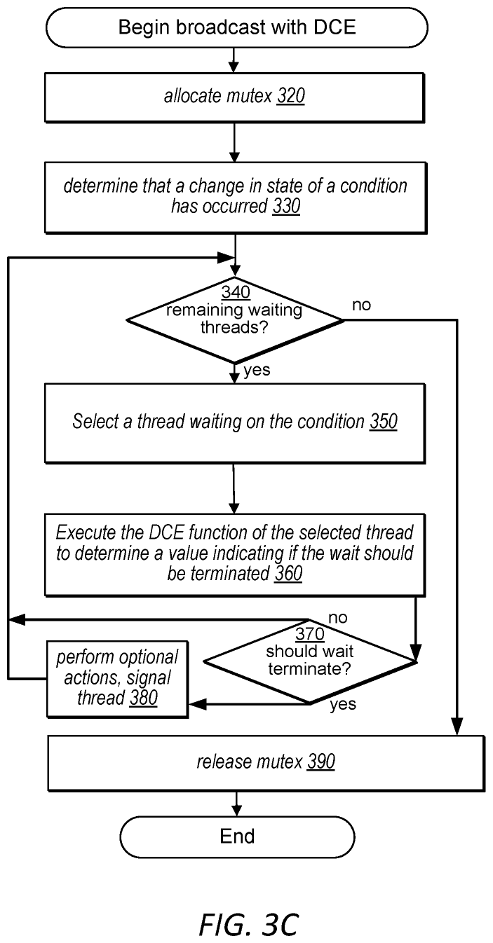

A thread 150 may wait on a change to condition variable 180 as shown in FIG. 3A by first allocating the mutex 170 then issuing a call to the wait function 156. This mutex 170 is used to synchronize, or serialize, accesses to the shared data 160. The call to the wait function may include information required to execute the DCE function 155. In some embodiments, this information may include an address, or reference, to an executable DCE function. The DCE may access additional data, including other data 190, to determine if the wait should be terminated or continue. Multiple threads 150 may simultaneously wait on a change to condition variable 180 and may use a common DCE function 155 or may use a plurality of different DCE functions 155, including using a different DCE function for each waiting thread 150.

The executable DCE function may be generated in different ways in various embodiments. In some embodiments, the executable DCE function may be generated as standalone function that returns a boolean, or two-valued, return value indicating if the wait should be terminated or continue. In such embodiments, the wait function 156 may be called with a reference to the standalone function. In other embodiments, the executable DCE function may be generated from instructions expressed as an anonymous, or unnamed, function presented inline, such as using a lambda expression, with the call to the wait function 156. These various methods for generating the executable DCE function are not intended to be limiting and any number of applications with any number of methods for generating the executable DCE function may be envisioned. Upon entering the wait function 156, the thread 150 is set to a non-runnable state and the mutex allocated by the thread 150 is released.

A thread 150 may signal a change to condition variable 180 to one or more other threads 150 as shown in greater detail in FIGS. 3B-3C. The thread 150 may first allocate the mutex 170 then issue a call to a signaling function. In some embodiments this signaling function may be a signal function 157, in other embodiments the signaling function may be a broadcast function 158 while in still other embodiments multiple signaling functions may be used. Once called, the signaling function may select one or more waiting threads 150 and execute the respective DCE functions provided by those threads when they called the respective wait functions 156. Waiting threads whose respective DCE functions indicate that the wait should be terminated are signaled to enter a runnable state while waiting threads whose respective DCE functions indicate that the wait should not be terminated are left in a non-runnable state.

FIGS. 2A-2B are flow diagrams illustrating methods and techniques for implementing synchronization of threads using condition variables, according to some embodiments. FIG. 2A illustrates the use of condition variables without the use of DCE while FIG. 2B illustrates the use of condition variables with DCE.

As shown in FIG. 2A, in some embodiments threads of an application, such as threads 150 of application 140, as discussed in connection with FIG. 1, may perform the below techniques. The threads of the application include a thread 210 and a signaling thread 220.

Synchronization begins with a thread 210 determining to wait on a change to condition variable such as the condition variable 180 as discussed in connection with FIG. 1. In some embodiments, at step 230a, the thread 210 may first allocate a mutex associated with the condition variable, such as the mutex 170 as discussed in connection with FIG. 1, and then call a wait function of a synchronization API, such as the wait function 156 as discussed in connection with FIG. 1, as shown in step 231. As a result of calling the wait function, the thread 210 is set to a non-runnable state and the allocated mutex is released.

In some embodiments, a signaling thread 220 may determine that a change to the condition variable is to be made. In some embodiments, as shown in step 232 the signaling thread 220 may first allocate the mutex associated with the condition variable. As shown in step 234, the signaling thread may then signal a waiting thread 210 of the change to the condition variable and then release the allocated mutex.

In some embodiments, as shown in step 236 a waiting thread is set to a runnable state responsive to the signaling performed in step 234. The waiting thread may then allocate the mutex associated with the condition variable, as shown in step 237, and execute, in some embodiments, to determine if the change to the condition variable indicates that the wait condition of the thread should be terminated, as shown in step 238. If the wait condition should not be terminated, the thread returns to step 230a to again request a wait on a change to condition variable. If the wait condition should be terminated, the process completes as shown in step 240.

FIG. 2B illustrates implementing synchronization of threads using condition variables with DCE. In some embodiments, threads of an application, such as threads 150 of application 140, as discussed in connection with FIG. 1, may perform the below techniques. The threads of the application include one or more threads 210 and a signaling thread 220.

Synchronization begins with a thread 210 determining to wait on a change to condition variable such as the condition variable 180 as discussed in connection with FIG. 1. In some embodiments, at step 230b, the thread 210 may first allocate a mutex associated with the condition variable, such as the mutex 170 as discussed in connection with FIG. 1, and then call a wait function of a synchronization API, such as the wait function 156 as discussed in connection with FIG. 1. The call to the wait function may include information required to execute a DCE function, such as DCE function 155 as discussed in connection with FIG. 1. As a result of calling the wait function, the thread 210 is set to a non-runnable state and the allocated mutex is released. In addition, in some embodiments the DCE function identified in the call to the wait function may be associated with the waiting thread 210.

In some embodiments, a signaling thread 220 may determine that a change to the condition variable is to be made. In some embodiments, as shown in step 232 the signaling thread 220 may first allocate the mutex associated with the condition variable.

In some embodiments, as shown in step 238 the signaling thread 210 may then execute the DCE function associated with a waiting thread to determine if the respective wait condition for the thread should terminate. If it is indicated that the wait should not be terminated, the thread is left in a non-runnable state and the allocated mutex is released, as shown in step 242. If, however, it is indicated that the wait should be terminated, the signaling thread 220 signals the waiting thread of the change of the condition variable and the allocated mutex is released, as shown in step 234. As shown in step 236 the waiting thread 210 is set to a runnable state responsive to the signaling performed in step 234 and the process completes as shown in step 240.

FIG. 3A is a flow diagram illustrating methods and techniques for implementing a wait function supporting condition variables with deferred condition evaluation, according to some embodiments. In some embodiments, a thread of an application, such as thread 210 of application 140, as discussed in connection with FIG. 1, may perform the methods and techniques to wait on a change to a condition variable.

Waiting begins with a thread determining to wait on a change to condition variable such as the condition variable 180 as discussed in connection with FIG. 1. In some embodiments, at step 300, the thread may first allocate a mutex associated with the condition variable, such as the mutex 170 as discussed in connection with FIG. 1. The thread then calls a wait function of a synchronization API, as shown in step 310, such as the wait function 156 as discussed in connection with FIG. 1. The call to the wait function may include information required to execute a DCE function, such as DCE function 155 as discussed in connection with FIG. 1. As a result of calling the wait function, the thread 210 is set to a non-runnable state and the allocated mutex is released. In addition, in some embodiments the DCE function identified in the call to the wait function may be associated with the waiting thread 210.

FIG. 3B is a flow diagram illustrating methods and techniques for implementing a signal function supporting condition variables with deferred condition evaluation, according to some embodiments. In some embodiments, a signaling thread of an application, such as thread 220 of application 140, as discussed in connection with FIGS. 1 and 2B, may perform the methods and techniques to signal a change to a condition variable.

In some embodiments, as shown in step 320 the signaling thread may first allocate the mutex associated with the condition variable. Then, a signaling thread may determine that a change to the condition variable is to be signaled, as shown in step 330. As shown in step 340, the signaling thread may then determine if any waiting threads remain to be signaled. If no threads remain, the process proceeds to step 390 where the allocated mutex may be released and the process completed. If waiting threads remain, a thread may be selected as shown in step 350.

As shown in step 360, the DCE function associated with the selected thread may then be executed to determine if the change to the condition variable indicates that the wait condition of the thread should be terminated and the thread unblocked. As shown in step 370, if the wait condition should not be terminated, the thread returns to step 340, otherwise the process proceeds to step 380.

A waiting thread has been selected whose associated DCE function indicates that the wait condition should be terminated. In some embodiments, optional actions may be performed by the signaling thread, as shown in step 380. As the signaling thread has currently allocated the mutex, these optional actions may be performed atomically with respect to all threads participating in the synchronization technique described herein. These actions may be included as part of the DCE function associated with the selected waiting thread in some embodiments, whereas in other embodiments the actions may be specified as part of a separate function. These various methods for providing optional actions to perform are not intended to be limiting and any number of techniques for specifying such actions may be envisioned. After such optional actions are performed in some embodiments, the selected waiting thread is signaled and the process advances to step 390.

As shown in step 390, once a waiting thread has been signaled or no waiting threads remain, the allocated mutex is released and the process is complete.

FIG. 3C is a flow diagram illustrating methods and techniques for implementing a broadcast function supporting condition variables with deferred condition evaluation, according to some embodiments. In some embodiments, a signaling thread of an application, such as thread 220 of application 140, as discussed in connection with FIGS. 1 and 2B, may perform the methods and techniques to broadcast a change to a condition variable.

In some embodiments, as shown in step 320 the signaling thread may first allocate the mutex associated with the condition variable. Then, a signaling thread may determine that a change to the condition variable is to be broadcast, as shown in step 330. As shown in step 340, the signaling thread may then determine if any waiting threads remain to be signaled. If no threads remain, the process proceeds to step 390 where the allocated mutex may be released and the process completed. If waiting threads remain, a thread may be selected as shown in step 350.

As shown in step 360, the DCE function associated with the selected thread may then be executed to determine if the change to the condition variable indicates that the wait condition of the thread should be terminated. As shown in step 370, if the wait condition should not be terminated, the thread returns to step 340, otherwise the process proceeds to step 380.

A waiting thread has been selected whose associated DCE function indicates that the wait condition should be terminated. In some embodiments, optional actions may be performed by the signaling thread, as shown in step 380. As the signaling thread has currently allocated the mutex, these optional actions may be performed atomically with respect to all threads participating in the synchronization technique described herein. These actions may be included as part of the DCE function associated with the selected waiting thread in some embodiments, whereas in other embodiments the actions may be specified as part of a separate function. These various methods for providing optional actions to perform are not intended to be limiting and any number of techniques for specifying such actions may be envisioned. After such optional actions are performed in some embodiments, the selected waiting thread is signaled and the process advances to step 340.

As shown in step 390, once no waiting threads remain, the allocated mutex is released and the process is complete.

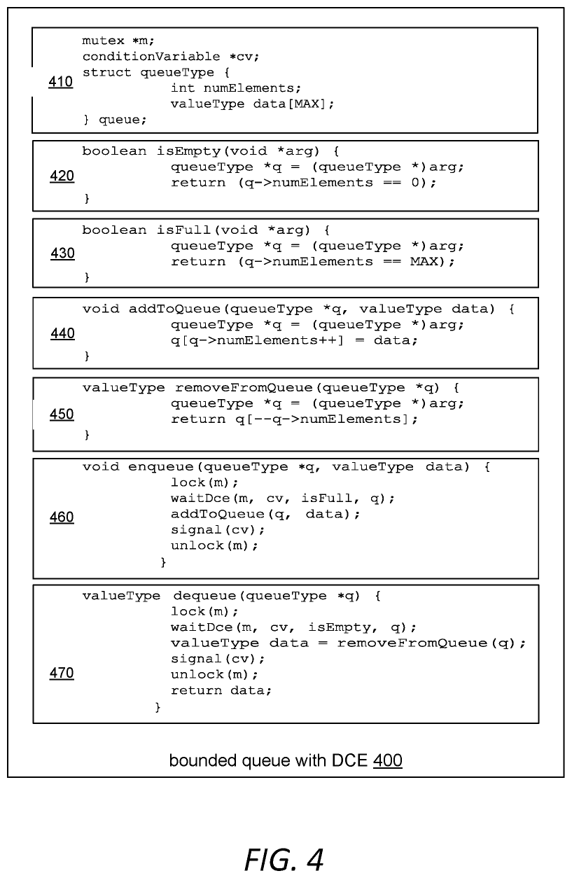

FIG. 4 is example code implementing a bounded queue algorithm using condition variables with deferred condition evaluation, according to some embodiments. A bounded queue is a classic application for condition variables-based synchronization between producers trying to insert items into a buffer (queue) with a limited capacity and consumers trying to remove items from the same buffer.

A bounded queue may commonly use two condition variables signaled by producers and consumers when they add or remove an element of the queue to notify their counterpart that the queue is no longer empty or full. The use of condition variables with DCE enables a simpler implementation using only one condition variable in some embodiments, as shown in FIG. 4. Some implementations of bounded queues using condition variables without DCE also use only one condition variable, but these implementations combine an empty queue condition variable and a full queue condition variable which means that all threads are signaled, that is that broadcast is used, when a new item is inserted into or an old one is removed from the queue.

FIG. 4 shows sample code for various synchronization functions implementing a bounded queue using condition variables with DCE, according to some embodiments. Shared data 410 accessible from all threads includes a controlling mutex and a condition variable. Adding items to and deleting items from the queue by participating threads are performed by the enqueue function 420 and dequeue function 430, respectively. The enqueue function 460 and dequeue function 470 respectively use the addToQueue function and removeFromQueue function to provide unsynchronized modifications to the queue itself. Finally, DCE functions isEmpty 420 and isFull 430 are used to determine if thread wait conditions are to be terminated.

The bounded queue may have a number of producer threads enqueuing items into a queue and a number of consumer threads dequeuing items from the queue, in some embodiments. Producer threads are prevented from adding queue data while the queue is full while consumer threads are prevented from removing data while the queue is empty.

As shown in 410, the queue consists of an array of data elements of a fixed size and a current indicator of the number of elements in the queue. An empty queue is indicated by a number of elements equal to zero while a full queue is indicated by a number of elements equal to the maximum allowable number of elements. As shown in 420 and 430, therefore, the DCE functions corresponding to empty and full queue conditions check for these corresponding number of elements values. This examplary implementation of the queue structure and corresponding DCE functions is one of many possible queue implementations and is not intended to be limiting.

Given the queue structure disclosed above, the queue adding and removing functions 440 and 450 respectively are implemented by accessing the highest numbered element in the queue for removals and accessing the first empty queue position for additions. This results in a so-called “Last In, First Out”, or LIFO, queue. This examplary LIFO queue implementation is one of many possible queue implementations and is not intended to be limiting.

In some embodiments, a producer thread may enqueue a data item by calling the enqueue function 460. The enqueue function first allocates the mutex shown in 410, then calls a waitDce function using the isFull DCE function to indicate when the wait condition should be terminated. In some embodiments, once the wait is terminated, the enqueue function adds data to the queue using the addToQueue function 440. The enqueue function then signals consumer threads that data has been added to the queue and releases the allocated lock.

In some embodiments, a consumer thread may dequeue a data item by calling the dequeue function 470. The dequeue function first allocates the mutex shown in 410, then calls a waitDce function using the isEmpty DCE function to indicate when the wait condition should be terminated. In some embodiments, once the wait is terminated, the dequeue function removes data from the queue using the removeFromQueue function 450. The dequeue function then signals producer threads that the queue is not full and releases the allocated lock.

### Performance Evaluation

The evaluate the performance of condition variables with DCE, a benchmark emulating a system that uses producer and consumer threads was implemented. The benchmark has an array of padded slots, each for one of the consumer threads, representing items for processing. A producer thread randomly picks one of the slots, checks that it is empty, and if so, writes a non-zero value into that slot then calls broadcast function. If the slot is not empty, indicating that the consumer has not processed yet the previous item, the producer spins until it becomes empty. Afterwards, the producer thread runs a random number generation loop for a random number of iterations and picks a new random slot. A consumer thread waits until its slot has a non-zero value, by calling the wait function, and processes the item (by writing zero into its slot).

The DCE function is emulated using traditional condition variables by using one condition variable per consumer thread, and a list structure. Each producer thread inserts a node into the list structure with a predicate, represented as a pointer to a function, an argument to the predicate that the predicate needs for evaluation, and a pointer to the thread's condition variable. After writing into a slot, the producer thread runs over the list calling predicates in the corresponding nodes until it finds the first predicate that evaluates to true. In that case, it calls signal with the condition variable stored in that node, notifying the corresponding consumer that its element is ready. Note that the producer wakes up at most one consumer thread at a time, as intended, instead of all waiting threads as does broadcast with legacy condition variables.

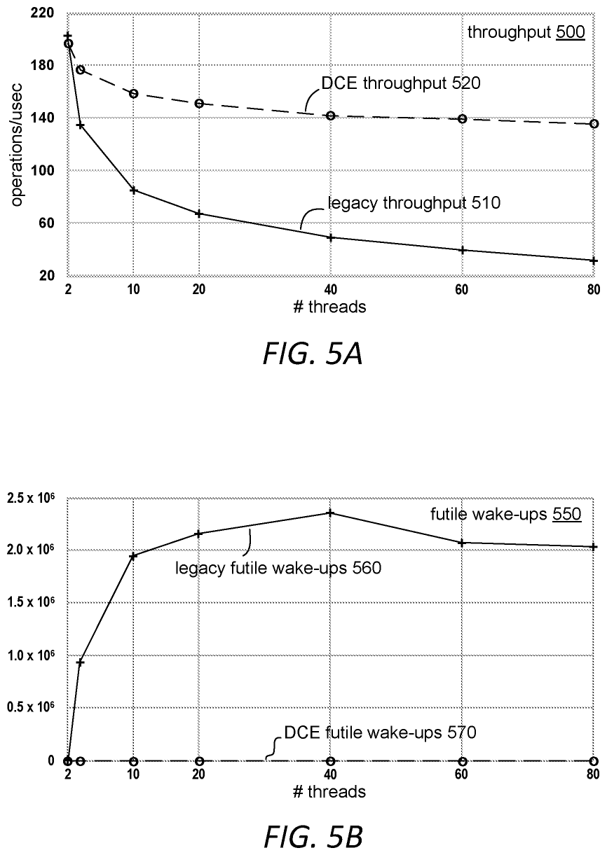

FIGS. 5A-5B illustrate example analyses of legacy and DCE throughput and futile wake-ups for a bounded queue application as discussed in FIG. 4. The analyses were performed on an Oracle X6-2 machine featuring two Intel Xeon CPU E5-2630 v4 processors with 10 hyperthreaded cores each. The number of consumer threads are varied from one to seventy nine, bringing the total number of threads to twice the capacity of the machine.

FIG. 5A shows throughput 500, in operations per microsecond, for legacy (non-DCE) 510 and DCE 520 implementations of the bounded queue application over a range of one to seventy nine consumer threads. For a single consumer thread, DCE throughput marginally trails legacy throughput due to modest additional overhead.

Furthermore, after the initial drop DCE throughput is maintained at a relatively same level of performance, regardless of the number of consumer threads. In the legacy implementation, however, throughput fades as we increase the number of consumer threads. This is because additional consumers introduce futile wakeups, leading to more context switches and, in general, more overhead to process each non-productive waking thread.

FIG. 5B shows the number of futile wake-ups per second 550 that occur for legacy (non-DCE) 560 and DCE 570 implementations of the bounded queue application over a range of one to seventy nine consumer threads. FIG. 5B shows that the DCE implementation produces no futile wake-ups under any number of consumer threads, while futile wake-ups for the legacy implementation remain low only for a number of consumer threads close to one. Increasing the number of consumer threads results in a rapid increase in the number of futile wake-ups for the legacy implementation, resulting in the rapidly declining throughput of the legacy implementation as shown in FIG. 5A.

### Representative System

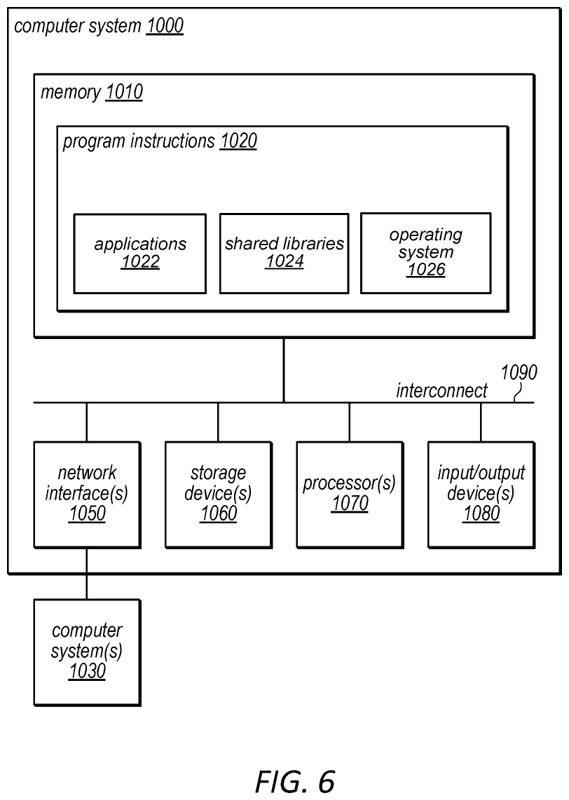

FIG. 6 illustrates a computing system configured to implement the methods and techniques described herein, according to various embodiments. The computer system 1000 may be any of various types of devices, including, but not limited to, a personal computer system, desktop computer, laptop or notebook computer, mainframe computer system, handheld computer, workstation, network computer, a consumer device, application server, storage device, a peripheral device such as a switch, modem, router, etc, or in general any type of computing device.

The mechanisms for implementing enforcing fairness on unlabeled data to improve modeling performance on a computing system, as described herein, may be provided as a computer program product, or software, that may include a non-transitory, computer-readable storage medium having stored thereon instructions, which may be used to program a computer system (or other electronic devices) to perform a process according to various embodiments. A non-transitory, computer-readable storage medium may include any mechanism for storing information in a form (e.g., software, processing application) readable by a machine (e.g., a computer). The machine-readable storage medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; electrical, or other types of medium suitable for storing program instructions. In addition, program instructions may be communicated using optical, acoustical or other form of propagated signal (e.g., carrier waves, infrared signals, digital signals, etc.)

In various embodiments, computer system 1000 may include one or more processors 1070; each may include multiple cores, any of which may be single or multi-threaded. Each of the processors 1070 may include a hierarchy of caches, in various embodiments. The computer system 1000 may also include one or more persistent storage devices 1060 (e.g. optical storage, magnetic storage, hard drive, tape drive, solid state memory, etc.) and one or more system memories 1010 (e.g., one or more of cache, SRAM, DRAM, RDRAM, EDO RAM, DDR 10 RAM, SDRAM, Rambus RAM, EEPROM, etc.). Various embodiments may include fewer or additional components not illustrated in FIG. 10 (e.g., video cards, audio cards, additional network interfaces, peripheral devices, a network interface such as an ATM interface, an Ethernet interface, a Frame Relay interface, etc.)

The one or more processors 1070, the storage device(s) 1050, and the system memory 1010 may be coupled to the system interconnect 1040. One or more of the system memories 1010 may contain program instructions 1020. Program instructions 1020 may be executable to implement various features described above, including a data generator 1022 as discussed above with regard to FIG. 5 and classifier(s) 1024 that may perform the various analysis on simulated data as discussed above with regard to FIGS. 1-4, in some embodiments as described herein. Program instructions 1020 may be encoded in platform native binary, any interpreted language such as Java™ byte-code, or in any other language such as C/C++, Java™, etc. or in any combination thereof. System memories 1010 may also contain LRU queue(s) 1026 upon which concurrent remove and add-to-front operations may be performed, in some embodiments.

In one embodiment, Interconnect 1090 may be configured to coordinate I/O traffic between processors 1070, storage devices 1070, and any peripheral devices in the device, including network interfaces 1050 or other peripheral interfaces, such as input/output devices 1080. In some embodiments, Interconnect 1090 may perform any necessary protocol, timing or other data transformations to convert data signals from one component (e.g., system memory 1010) into a format suitable for use by another component (e.g., processor 1070). In some embodiments, Interconnect 1090 may include support for devices attached through various types of peripheral buses, such as a variant of the Peripheral Component Interconnect (PCI) bus standard or the Universal Serial Bus (USB) standard, for example. In some embodiments, the function of Interconnect 1090 may be split into two or more separate components, such as a north bridge and a south bridge, for example. In addition, in some embodiments some or all of the functionality of Interconnect 1090, such as an interface to system memory 1010, may be incorporated directly into processor 1070.

Network interface 1050 may be configured to allow data to be exchanged between computer system 1000 and other devices attached to a network, such as other computer systems, or between nodes of computer system 1000. In various embodiments, network interface 1050 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1080 may, in some embodiments, include one or more display terminals, keyboards, keypads, touchpads, scanning devices, voice or optical recognition devices, or any other devices suitable for entering or retrieving data by one or more computer system 1000. Multiple input/output devices 1080 may be present in computer system 1000 or may be distributed on various nodes of computer system 1000. In some embodiments, similar input/output devices may be separate from computer system 1000 and may interact with one or more nodes of computer system 1000 through a wired or wireless connection, such as over network interface 1050.

Those skilled in the art will appreciate that computer system 1000 is merely illustrative and is not intended to limit the scope of the methods for providing enhanced accountability and trust in distributed ledgers as described herein. In particular, the computer system and devices may include any combination of hardware or software that may perform the indicated functions, including computers, network devices, internet appliances, PDAs, wireless phones, pagers, etc.

Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 800 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

Although the embodiments above have been described in considerable detail, numerous variations and modifications will become apparent to those skilled in the art once the above disclosure is fully appreciated. It is intended that the following claims be interpreted to embrace all such variations and modifications.

1. A system, comprising:
at least one processor;
a memory, comprising program instructions that when executed by the at least one processor cause the at least one processor to:
receive, over a programmatic interface, a request to wait on a condition from a thread, wherein the request to wait comprises a function that, when executed, returns a value indicating if the wait of the thread is to be terminated;
place the thread in a non-runnable state;
change the condition, wherein to change the condition the program instructions, that when executed by the at least one processor, cause the at least one processor to:
execute the function;
leave the thread in the non-runnable state responsive to the returned value of the function indicating that the wait of the thread should not be terminated; and
place the thread in the runnable state responsive to the returned value of the function indicating that the wait of the thread should be terminated.

2. The system of claim 1, comprising additional program instructions that when executed by the at least one processor cause the at least one processor to:
receive, over the programmatic interface, another request to wait on the condition from another thread while the thread is in the non-runnable state, wherein the other request to wait comprises another function that, when executed, returns a value indicating if the wait of the other thread is to be terminated;
place the other thread in the non-runnable state;
wherein to change the condition additional program instructions, that when executed by the at least one processor, cause the at least one processor to:
execute the other function;
leave the other thread in the non-runnable state responsive to the returned value of the other function indicating that the wait of the other thread should not be terminated.
place the thread in the runnable state responsive to the returned value of the other function indicating that the wait of the other thread should be terminated.

3. The system of claim 2, comprising additional program instructions that when executed by the at least one processor cause the at least one processor to submit, over the programmatic interface, a request to broadcast the change to the condition to the thread and the other thread.

4. The system of claim 1, comprising additional program instructions that when executed by the at least one processor cause the at least one processor to:
receive, over the programmatic interface, another request to wait on the condition from another thread while the thread is in the non-runnable state, wherein the other request to wait comprises another function that, when executed, returns a value indicating if the wait of the other thread is to be terminated;
place the other thread in the non-runnable state;
execute the other function responsive to the value indicating that the wait of the thread should not be terminated, and responsive to receipt of the other value:
wherein to change the condition additional program instructions, that when executed by the at least one processor, cause the at least one processor to:
responsive to the value indicating that the wait of the thread should not be terminated:
execute the other function;
leave the other thread in the non-runnable state responsive to the returned value of the other function indicating that the wait of the other thread should not be terminated.
place the thread in the runnable state responsive to the returned value of the other function indicating that the wait of the other thread should be terminated.

5. The system of claim 4, comprising additional program instructions that when executed by the at least one processor cause the at least one processor to submit, over the programmatic interface, a request to signal the change to the wait condition to one of the thread and the other thread.

6. The system of claim 1, comprising additional program instructions that when executed by the at least one processor cause the at least one processor to:
receive, over the programmatic interface, a third request to wait on the condition from a third thread, wherein to implement the third request to wait the additional program instructions that when executed by the at least one processor cause the at least one processor request the wait comprising a third function that, when executed, returns a third value indicating the wait of the third thread is to be terminated.

7. A method, comprising:
receiving from a thread a request to wait on a condition comprising instructions that, when performed, indicate if the thread is to be unblocked;
blocking the thread;
changing the condition, comprising:
leaving the thread blocked responsive to the instructions indicating that the thread should not be unblocked; and
unblocking the thread responsive to the instructions indicating that the thread should be unblocked.

8. The method of claim 7, further comprising:
receiving from another thread another request to wait on the condition comprising other instructions that, when performed, indicate if the other thread is to be unblocked;
blocking the other thread;
wherein the changing the condition further comprises:
leaving the other thread blocked responsive to the other instructions indicating that the other thread should not be unblocked; and
unblocking the other thread responsive to the other instructions indicating that the other thread should be unblocked.

9. The method of claim 8, wherein the changing is performed by a third thread, and wherein the changing further comprises submitting, over the programmatic interface, a request to broadcast a change to the condition to the thread and the other thread.

10. The method of claim 7, further comprising:
receiving from another thread another request to wait on the condition while the thread is blocked, wherein the other request to wait on the condition comprises instructions that, when performed, indicate if the other thread is to be unblocked;
blocking the other thread;
wherein changing the condition further comprises:
performing the other instructions responsive to the instructions indicating that the thread should not be unblocked, and responsive to performing the other instructions:
leaving the other thread blocked responsive to the other instructions indicating that the other thread should not be unblocked; and
unblocking the other thread responsive to the other instructions indicating that the other thread should be unblocked.

11. The method of claim 10, wherein the changing is performed by a third thread, and wherein the changing further comprises submitting, over the programmatic interface, a request to signal the change to the wait condition to one of a plurality of blocked threads comprising the thread and the other thread.

12. The method of claim 7, further comprising:
receiving from another thread another request to wait on the condition, wherein performing the other request to wait comprises submitting a different request to wait on the condition comprising other instructions that, when performed, indicate that the other thread is to be unblocked.

13. The method of claim 7, wherein the request to wait further comprises additional instructions to perform an operation in a critical section.

14. One or more non-transitory computer-accessible storage media storing program instructions that when executed on or across one or more processors cause the one or more processors to implement:
changing a condition on which a plurality of threads are waiting, wherein each of the plurality of waiting threads comprises associated instructions that, when executed, indicate if the wait of the respective thread is to be terminated, and wherein changing the condition comprises:
executing the associated instructions of a thread of the plurality of waiting threads;
terminating the wait of the thread responsive to the associated instructions of the thread indicating that the wait of the thread should be terminated.

15. The one or more non-transitory computer-accessible storage media of claim 14, wherein changing the condition further comprises:
executing the associated instructions of another thread of the plurality of waiting threads;
terminating the wait of the thread responsive to the associated instructions of the other thread indicating that the wait of the thread should be terminated.

16. The one or more non-transitory computer-accessible storage media of claim 15, wherein the changing the condition on which the plurality of threads are waiting comprises submitting a request to broadcast the change of the condition to the plurality of waiting threads.

17. The one or more non-transitory computer-accessible storage media of claim 14, wherein changing the condition further comprises:
executing the associated instructions of another thread of the plurality of waiting threads responsive to the associated instructions of the thread indicating that the wait of the thread should not be terminated;
terminating the wait of the other thread responsive to the associated instructions of the other thread indicating that the wait of the thread should be terminated.

18. The one or more non-transitory computer-accessible storage media of claim 17, wherein the changing the condition on which the plurality of threads are waiting comprises submitting a request to signal the changing the condition to one of the plurality of waiting threads.

19. The one or more non-transitory computer-accessible storage media of claim 14, wherein each of the plurality of waiting threads comprises additional associated instructions to be executed in a critical section, and wherein changing the condition further comprises executing the additional associated instructions of the thread.

20. The one or more non-transitory computer-accessible storage media of claim 14, wherein the condition is one of a plurality of conditions.
